(19) United States
(12) Patent Application Publication
(10) Pub. No.: US 2011/0028021 A1
(43) Pub. Date: Feb. 3, 2011

(54) ELECTRICAL CONNECTOR HAVING A DIELECTRIC INSERT FOR RETAINING AN ELECTRICAL CONTACT

(76) Inventors: Jared Evan Rossman, Camp Hill, PA (US); Steven Lee Flickinger, Hummelstown, PA (US); Phillip Clay Brandberg, Carlisle, PA (US)

Correspondence Address: ROBERT J. KAPALKA;TYCO TECHNOLOGY RESOURCES, 4550 NEW LINDEN HILL ROAD, SUITE 140, WILMINGTON, DE, 19808, US

(21) Appl. No.: 12/510,904

(22) Filed: Jul. 28, 2009

(51) Int. Cl. H01R 4/48

(52) U.S. Cl. 439/346

(57) ABSTRACT

An electrical connector includes a housing having a mating interface and an interior chamber, an electrical contact having a terminating segment and a mating segment, and a dielectric insert held within the interior chamber of the housing. The dielectric insert includes a contact channel and a resilient finger extending into the contact channel. The terminating segment of the electrical contact extends within the contact channel of the dielectric insert. The resilient finger is engaged with the terminating segment of the electrical contact to retain the electrical contact within the interior chamber of the housing such that the mating segment of the electrical contact extends along the mating interface of the housing.

### BACKGROUND OF THE INVENTION

The subject matter herein relates generally to electrical connectors, and more particularly, to a dielectric insert for retaining an electrical contact within the housing of an electrical connector.

Electrical connectors are used to electrically connect a wide variety of electrical components. For example, electrical drawer connectors are used to connect various workstations and other electrical components to wide-area network (WAN) and local-area network (LAN) servers. Drawer connectors typically include a housing that holds a plurality of electrical contacts having terminating segments that terminate electrical wires and/or electrical cables that extend from the server. The electrical contacts include mating segments that extend along a mating interface of the housing of the drawer connector. The housing can be mated with the mating connector of an electrical component at the mating interface to electrically connect the electrical component to the server.

The terminating segments of the electrical contacts of drawer connectors are sometimes held within a mounting cavity of the housing using a dielectric insert and a metal retention clip. Specifically, the dielectric insert is first loaded into the mounting cavity of the housing. Thereafter, the metal retention clip is hand-loaded into a contact channel that extends through the dielectric insert, such that the dielectric insert extends around the metal retention clip. The electrical contact is then inserted into an opening within the metal retention clip such that the metal retention clip extends around the terminating segment of the electrical contact. The metal retention clip includes a plurality of fingers that extend radially inwardly and engage the terminating segment of the electrical contact to retain the electrical contact within the mounting cavity of the housing. Using the metal retention clip to retain the electrical contact within the mounting cavity is not without disadvantages. For example, the metal retention clip may increase a complexity and/or a number of components of the drawer connector, which may increase a cost of the drawer connector. Moreover, it may be difficult and/or time-consuming to separately load each of the dielectric insert, the metal retention clip, and the electrical contact within the mating cavity of the housing. The metal retention clip may therefore increase a cost, difficulty, and/or time of assembling the drawer connector.

### BRIEF DESCRIPTION OF THE INVENTION

In one embodiment, an electrical connector includes a housing having a mating interface and an interior chamber, an electrical contact having a terminating segment and a mating segment, and a dielectric insert held within the interior chamber of the housing. The dielectric insert includes a contact channel and a resilient finger extending into the contact channel. The terminating segment of the electrical contact extends within the contact channel of the dielectric insert. The resilient finger is engaged with the terminating segment of the electrical contact to retain the electrical contact within the interior chamber of the housing such that the mating segment of the electrical contact extends along the mating interface of the housing.

In another embodiment, an electrical connector includes a housing having a mating interface and an interior chamber, an electrical contact having a terminating segment and a mating segment, and a dielectric insert held within the interior chamber of the housing. The dielectric insert includes a base having a contact channel extending therethrough and resilient fingers extending from the base into the contact channel. The terminating segment of the electrical contact extends within the contact channel of the dielectric insert. The resilient fingers are spaced apart around a periphery of the terminating segment of the electrical contact. The resilient fingers include free ends that are engaged with the terminating segment of the electrical contact to retain the electrical contact within the interior chamber of the housing such that the mating segment of the electrical contact extends along the mating interface of the housing.

### BRIEF DESCRIPTION OF THE DRAWINGS

FIG. 1 is a perspective view of an exemplary embodiment of an electrical connector.

FIG. 2 is a cross-sectional of an exemplary embodiment of a housing of the electrical connector shown in FIG. 1.

FIG. 3 is a perspective view of an exemplary embodiment of a dielectric insert of the electrical connector shown in FIG. 1.

FIG. 4 is a cross-sectional view of the dielectric insert shown in FIG. 3 taken along line 4-4 of FIG. 3.

FIG. 5 is a perspective view of a plurality of exemplary embodiments of other dielectric inserts of the electrical connector 10 shown in FIG. 1.

FIG. 6 is a cross-sectional view of a portion of the electrical connector shown in FIG. 1 illustrating the dielectric insert shown in FIG. 3 retaining an exemplary embodiment of an electrical contact within the housing shown in FIG. 2.

### DETAILED DESCRIPTION OF THE INVENTION

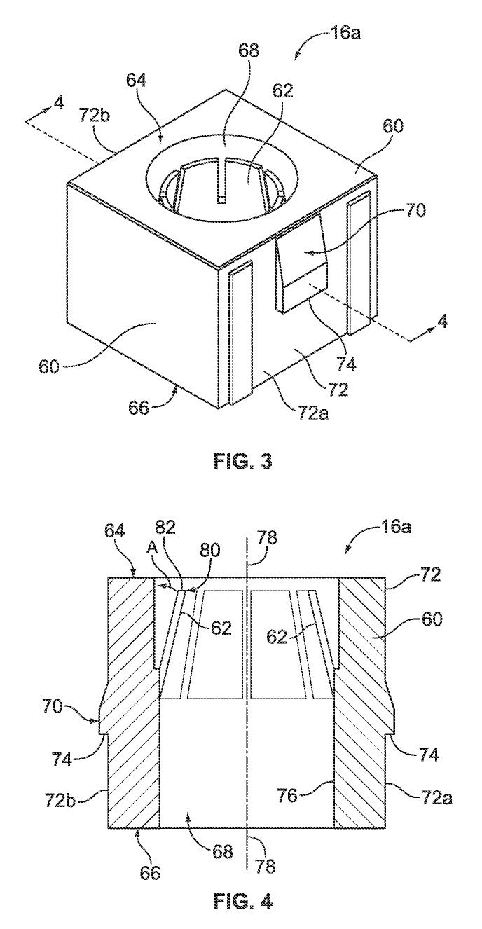

FIG. 1 is a perspective view of an exemplary embodiment of an electrical connector 10. The electrical connector 10 includes a housing 12 that holds a plurality of electrical contacts 14. Only some of the electrical contacts 14 are visible in FIG. 1. The electrical contacts 14 held by the housing 12 may include signal contacts, ground contacts, and/or power contacts. More specifically, each electrical contact 14 that is held by the housing 12 may transmit electrical data signals, electrical ground, or electrical power. The electrical connector 10 may be used, for example, as a drawer connector for network servers (not shown) and/or the like. However, the subject matter described and/or illustrated herein is not limited to drawer connectors. Rather, the subject matter described and/or illustrated herein may be used as, and/or with, any type of electrical connector for electrically connecting any electrical components together. As will be descried below, the electrical contacts 14 are held by the housing 12 using dielectric inserts 16 having resilient fingers 62 (FIGS. 3-6) that engage the electrical contacts 14.

The housing 12 includes a base 20 that extends a length from an end 22 to an opposite end 24. The housing base 20 includes a mating side 26 that extends from the end 22 to the end 24, and a terminating side 28 that extends from the end 22 to the end 24. In the exemplary embodiment, the terminating side 28 is opposite the mating side 26. Alternatively, the mating side 26 and the terminating side 28 intersect. The mating side 26 defines a portion of a mating interface 30 at which the electrical connector 10 is configured to be mated with a mating connector (not shown). When mated with the mating connector, each of the electrical contacts 14 of the electrical connector 10 is engaged with, and thereby electrically connected to, one or more corresponding electrical contacts (not shown) of the mating connector. An electrical connection between the electrical connector 10 and the mating connector can thereby be established by mating the electrical connector 10 and the mating connector together at the mating interface 30.

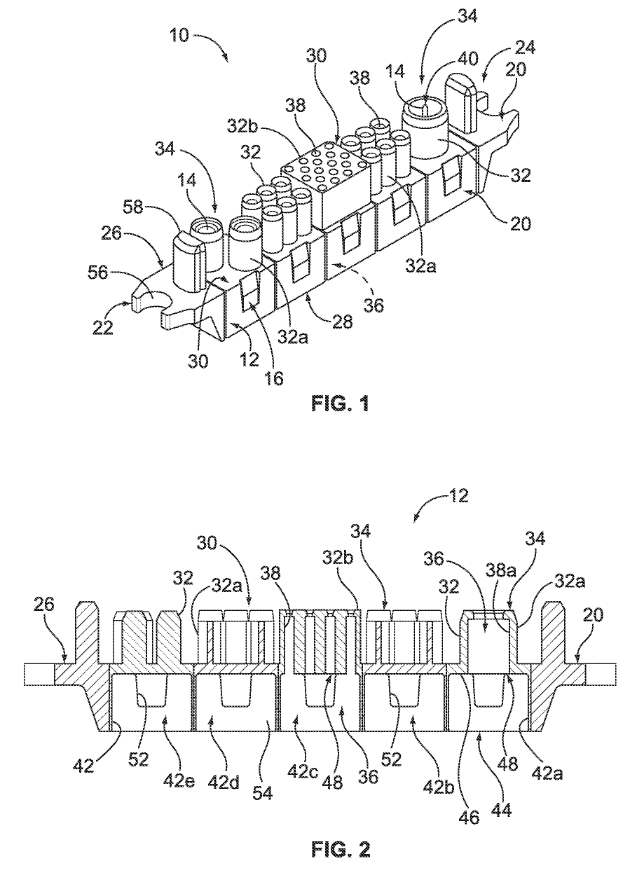

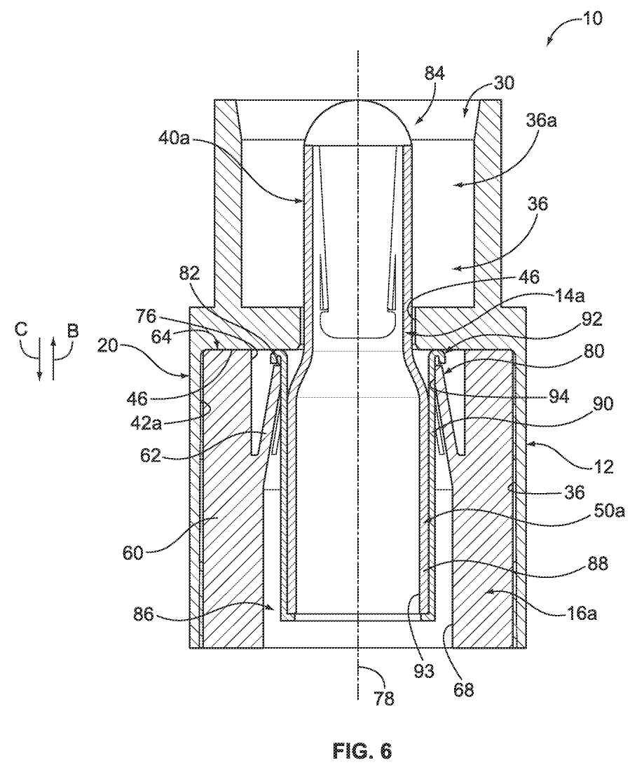

FIG. 2 is a cross-sectional view of an exemplary embodiment of the housing 12. Referring now to FIGS. 1 and 2, in addition to the mating side 26 of the housing base 20, in the exemplary embodiment the mating interface 30 is defined by a plurality of contact extensions 32 that extend outwardly from the mating side 26 of the housing base 20. Each contact extension 32 extends a length from the mating side 26 of the housing base 20 to a free end 34. The housing 12 includes an interior chamber 36 within which the electrical contacts 14 (FIGS. 1 and 6) are held. Each contact extension 32 includes one or more mating cavities 38 that extend through the length of the contact extension 32. The mating cavities 38 define a portion of the interior chamber 36 of the housing 12. As will be described below, each mating cavity 38 holds a mating segment 40 (not shown in FIG. 2) of one or more of the electrical contacts 14 therein.

In the exemplary embodiment, the contact extensions 32 include a plurality of contact barrels 32a and a contact block 32b. Each contact barrel 32a includes a cylindrically shaped body that includes a single one of the mating cavities 38 extending therethrough. The contact block 32b includes a rectangular shaped body that includes a plurality of the mating cavities 38 extending therethrough. Although sixteen are shown, the housing 12 may include any number of the contact extensions 32, including any number of the contact barrels 32a and any number of the contact blocks 32b. Moreover, each contact extension 32 may include any number of the mating cavities 38 for holding any number of the electrical contacts 14. In addition or alternative to the cylindrical and rectangular shapes shown herein, each contact extension 32 may include any other shape.

As best seen in FIG. 2, the terminating side 28 of the housing base 20 includes a plurality of mounting cavities 42 extending therein. The mounting cavities 42 define a portion of the interior chamber 36 of the housing 12. Each mounting cavity 42 extends into the housing base 20 from an open end 44 to a bottom 46. Each mounting cavity 42 is aligned along the length of the housing base 20 with one or more corresponding ones of the contact extensions 32. Accordingly, each mounting cavity 42 is aligned with one or more corresponding mating cavities 38 of the contact extensions 32. One or more openings 48 extend through the bottom 46 of each of the mounting cavities 42 such that each mating cavity 38 fluidly communicates with the corresponding mounting cavity 42 with which the mating cavity 38 is aligned. As will be described below, each mounting cavity 42 holds a corresponding one of the dielectric inserts 16 (FIGS. 1 and 3-6) therein. The dielectric inserts 16 hold terminating segments 50 (FIG. 6) of one or more of the electrical contacts 14 such that the mating segment 40 (FIGS. 1 and 6) of the electrical contact 14 extends within the corresponding mating cavity 38. Although five are shown, the terminating side 28 of the housing base 20 may include any number of the mounting cavities 42, each of which may hold any number of the dielectric inserts 16 and any number of the electrical contacts 14. Although shown as including a rectangular shape, each mounting cavity 42 may additionally or alternatively include any other shape.

The housing base 20 includes a plurality of optional latch openings 52 for latching the dielectric inserts 16 within the mounting cavities 42. The latch openings 52 extend through walls 54 of the housing base 20 that define the mounting cavities 42. In addition or alternatively to the latch openings 52, the housing base 20 may include any other type of latch element for latching the dielectric inserts 16 within the mounting cavities 42, such as, but not limited to, extensions, arms, shoulders, tabs, an interference (or clearance) fit, and/or the like. The housing base 20 may include any number of the latch openings 52. Each latch opening 52 may be referred to herein as a “latch feature”.

Referring again to FIG. 1, the housing base 20 optionally includes one or more mounting features 56 for mounting the housing 12 on a structure, such as, but not limited to, a panel, a housing, a wall, a rack, and/or the like. Although two are shown, the housing base 20 may include any number of the mounting features 56. In the exemplary embodiment, each mounting feature 56 is located at a corresponding one of the ends 22 and 24 of the housing base 20. However, the housing base 20 may additionally or alternatively include one or more mounting features 56 at any other location along the length of the housing base 20 than the ends 22 and/or 24. Moreover, although shown as openings, each mounting feature 56 may additionally or alternatively include any other structure, such as, but not limited to, extensions, clips, latches, arms, other types of fasteners, and/or the like.

Optionally, the housing base 20 includes one or more alignment extensions 58 for aligning the housing 12 with the mating connector during mating of the electrical connector 10 with the mating connector. In the exemplary embodiment, each of the alignment extensions 58 extends outwardly from the mating side 26 of the housing base 20 adjacent a corresponding one of the ends 22 and 24 of the housing base 20. The alignment extensions 58 are each received within a corresponding alignment opening (not shown) of the mating connector during mating therewith. In addition or alternative to the alignment extensions 58, the housing base 20 may include one or more alignment openings (not shown) that receives an alignment extension (not shown) of the mating connector therein. The housing base 20 may include any number of the alignment extensions 58. In the exemplary embodiment, the housing base 20 includes two alignment extensions 58. Each of the alignment extensions 58 may alternatively be located at any other location along the length of the housing base 20 than adjacent the ends 22 and/or 24.

FIG. 3 is a perspective view of an exemplary embodiment of one of the dielectric inserts 16a. FIG. 4 is a cross-sectional view of the dielectric insert 16a taken along line 4-4 of FIG. 3. Referring now to FIGS. 3 and 4, the dielectric insert 16a is configured to be received within a corresponding one of the mounting cavities 42a (FIGS. 2 and 6). The dielectric insert 16a includes a base 60 and one or more resilient fingers 62 extending from the base 60. The base 60 extends a length from an end 64 to an opposite end 66. A contact channel 68 extends through the length of the base 60. Specifically, the contact channel 68 extends through the ends 64 and 66 and completely through the base 60 therebetween. The contact channel 68 is configured to hold the terminating segment 50 (FIG. 6) of a corresponding one of the electrical contacts 14 (FIGS. 1 and 6) therein. Although shown as cylindrical, the contact channel 68 may additionally or alternatively include any other shape.

The base 60 of the dielectric insert 16a is optionally shaped complementary to the mounting cavity 42a for reception therein. In the exemplary embodiment, the base 60 of the dielectric insert 16a includes a rectangular shape that is complementary to the rectangular shape of the mounting cavity 42a. However, the base 60 of the dielectric insert 16a may additionally or alternatively include any other shape for reception within a mounting cavity 42 having any shape. The base 60 includes one or more optional latch tabs 70 that cooperate with the latch openings 52 (FIG. 2) of the housing base 20 (FIGS. 1, 2, and 6) to latch the dielectric insert 16a within the mounting cavity 42a. Each latch tab 70 extends outwardly from a side 72 of the base 60 of the dielectric insert 16a and includes a shoulder 74. As the dielectric insert 16a is loaded into the mounting cavity 42a, the latch tabs 70 are each received within a corresponding one of the latch openings 52. The shoulders 74 engage surfaces of the wall 54 (FIG. 2) of the housing base 20 that define the latch openings 52 to latch the dielectric insert 16a within the mounting cavity 42a. In addition or alternatively to the latch tabs 70, the base 60 of the dielectric insert may include any other type of latch element for latching the dielectric insert 16a within the mounting cavity 42a, such as, but not limited to, openings and/or the like. In some embodiments, and in addition or alternative to the latch tabs 70, the dielectric insert 16a is held within the mounting cavity 42a via an interference, or clearance, fit between the base 60 and the housing 12. The base 60 of the dielectric insert 16a may include any number of the latch tabs 70. In the exemplary embodiment, the base 60 of the dielectric insert 16a includes two latch tabs 70 (only one is visible in FIG. 1) located on opposite sides 72a and 72b of the base 60. In addition or alternative to the sides 72a and 72b, the base 60 may include latch tabs 70 at any other locations thereon. Each of the latch tabs 70 may be referred to herein as a “latch element”.

Referring now to FIG. 4, the base 60 of the dielectric insert 16a includes an interior surface 76 that defines the contact channel 68. The contact channel 68 extends a length through the base 60 along a central longitudinal axis 78. Each resilient finger 62 extends outwardly from the interior surface 76 of the base 60 into the contact channel 68. In other words, the resilient fingers 62 extend outwardly from the interior surface 76 of the base 60 radially inward relative to the central longitudinal axis 78 and along the length of the contact channel 68 toward the end 64 of the base 60. Each resilient finger 62 extends a length from the interior surface 76 of the base 60 to a tip 80. The tip 80 may also be referred to herein as a “free end”. Each tip 80 includes an end surface 82. The tips 80 of the resilient fingers 62 are configured to engage the terminating segment 50 (FIG. 6) of a corresponding one of the electrical contacts 14 (FIGS. 1 and 6) to hold the electrical contact 14 within the contact channel 68. For example, the end surface 82 of each tip 80 engages the corresponding electrical contact 14.

The tips 80 of the resilient fingers 62 are biased to a locked position, which is shown in FIG. 4. In other words, the tips 80 are in the locked position when the resilient fingers 62 are in the natural, or undeformed, state thereof. Each tip 80 is movable from the locked position, and against the bias, radially outward relative to the central longitudinal axis 78 and toward the interior surface 76 of the base 60. Movement of the tips 80 radially outward relative to the central longitudinal axis 78 and toward the interior surface 76 of the base 60 is indicated in FIG. 4 by the arc A. As will be described below, in the locked position, the tips 80 of the resilient fingers 62 are engaged with the corresponding electrical contact 14.

Referring again to FIG. 3, the resilient fingers 62 are spaced apart from one another about a periphery of the contact channel 68. In other words, the resilient fingers 62 are spaced apart from each other about the interior surface 76 of the base 60 of the dielectric insert 16a. In the exemplary embodiment, each resilient finger 62 includes a rectangular shape; however, each resilient finger 62 may additionally or alternatively include any other shape. Moreover, although the end surfaces 82 of the tips 80 are shown herein as being approximately planar, the end surface 82 of each tip 80 may additionally or alternatively include any other shape. For example, in some alternative embodiments, the end surface 82 of one or more of the tips 80 includes a curved shape, a v-shape, and/or the like. In some embodiments, the end surface 82 or another portion of the one or more of the tips 80 may include a shape that is complementary to the shape of the portion of the electrical contact 14 that the tip 80 engages. Any number of the resilient fingers 62 may extend within the contact channel 68 of the dielectric insert 16a. In the exemplary embodiment, the dielectric insert 16a includes eight resilient fingers 62, only six of which are visible in FIG. 3.

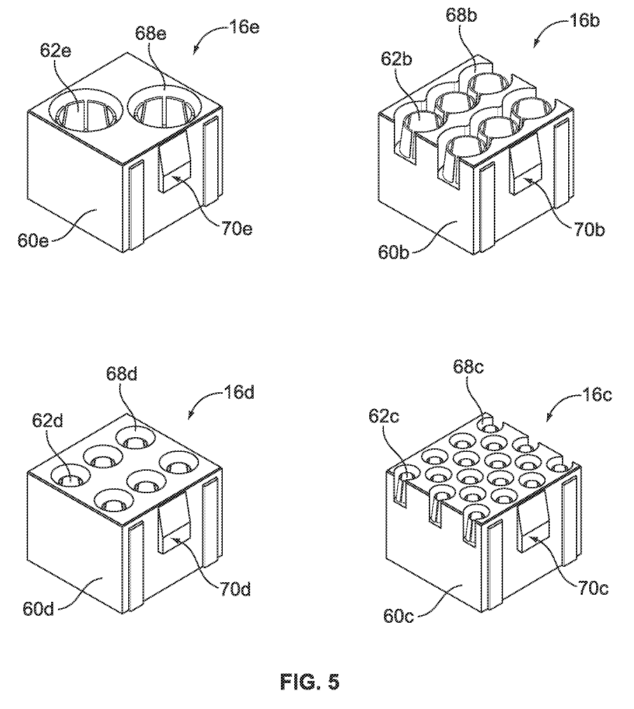

Although shown and described as having only a single contact channel 68 for holding a single electrical contact 14, the dielectric insert 16a may include any number of contact channels 68 for holding any number of the electrical contacts 14. For example, FIG. 5 is a perspective view of a plurality of exemplary embodiments of other dielectric inserts 16b, 16c, 16d, and 16e of the electrical connector 10 (FIGS. 1 and 6). The dielectric inserts 16b, 16c, 16d, and 16e are configured to be received within mounting cavities 42b, 42c, 42d, and 42e (FIG. 2), respectively, of the housing 12 of the electrical connector 10. Each dielectric insert 16b, 16c, 16d, and 16e includes a plurality of respective contact channels 68b, 68c, 68d, and 68e. For example, the dielectric inserts 16b and 16d each include a respective base 60b and 60d having six respective contact channels 68b and 68d extending through the length thereof. Each contact channel 68b and 68d holds a corresponding one of the electrical contacts 14 (FIGS. 1 and 6) therein. Four resilient fingers 62b and 62d extend within each of the contact channels 68b and 68d, respectively, for holding the corresponding electrical contact 14 therein. Similar to the dielectric insert 16a (FIGS. 3, 4, and 6), the bases 60b and 60d of the respective dielectric inserts 16b and 16d include one or more optional latching tabs 70b and 70d, respectively, for latching the dielectric inserts 16b and 16d within the respective mounting cavities 42b and 42d.

The dielectric insert 16c includes a base 60c having eighteen contact channels 68c extending through the length thereof. Each contact channel 68c of the dielectric insert 16c holds a corresponding one of the electrical contacts 14 therein. Two resilient fingers 62c extend within each of the contact channels 68c for holding the corresponding electrical contact 14 therein. The base 60c of the dielectric insert 16c includes one or more optional latching tabs 70c for latching the dielectric insert 16c within the mounting cavity 42c.

Two contact channels 68e extend through the length of the base 60e of the dielectric insert 16e. The contact channels 68e of the dielectric insert 16e each hold a corresponding one of the electrical contacts 14 therein. Each contact channel 68e includes eight resilient fingers 62e for holding the corresponding electrical contact 14 therein. One or more optional latching tabs 70e are provided on the dielectric insert 16e for latching the dielectric insert 16e within the mounting cavity 42e.

FIG. 6 is a cross-sectional view of a portion of the electrical connector 10 illustrating the dielectric insert 16a retaining an exemplary embodiment of an electrical contact 14a within the housing 12. The electrical contact 14a includes a mating segment 40a and a terminating segment 50a. In the exemplary embodiment, the mating and terminating segments 40a and 50a, respectively, define respective ends 84 and 86 of the electrical contact 14a. Alternatively, the mating segment 40a and/or the terminating segment 50a are located along other portions of the electrical contact 14a besides the ends 84 and 86, respectively. In the exemplary embodiment, the mating segment 40a of the electrical contact 14a is a pin that is configured to be received within a receptacle (not shown) of the corresponding electrical contact (not shown) of the mating connector (not shown). However, the mating segment 40a of the electrical contact 14a may alternatively include any other type of contact structure, such as, but not limited to, a receptacle (not shown) that is configured to receive a portion of the corresponding electrical contact of the mating connector therein, and/or the like.

In the exemplary embodiment, the terminating segment 50a of the electrical contact 14a includes an inner shell 88 and a sleeve 90 extending at least partially around the inner shell 88. The sleeve 90 includes a shoulder 92. In some alternative embodiments, the terminating segment 50a of the electrical contact 14a does not include the sleeve 90. In such embodiments wherein the terminating segment 50a does not include the sleeve 90, the inner shell 88 (which may be referred to as a “shell”) includes a shoulder (not shown), which is optionally formed integrally therewith. The inner shell 88 of the terminating segment 50a includes an opening 93 for receiving an electrical conductor (not shown), for example an electrical conductor of an electrical cable (not shown) and/or an electrical wire (not shown). The inner shell 88 is crimped about the electrical conductor to mechanically connect the electrical conductor to the terminating segment 50a as well as establish an electrical connection therebetween. The terminating segment 50a is thereby configured to terminate the electrical cable and/or electrical wire in the exemplary embodiment. Alternatively, the terminating segment 50a includes any other type of contact structure, such as, but not limited to, a surface mount structure, a press-fit structure, a pin, and/or the like, for example, for electrically connecting the terminating segment 50a to a circuit board (not shown).

The base 60 of the dielectric insert 16a is received within the mounting cavity 42a of the housing base 20 such that the end 64 of the base 60 engages the bottom 46 of the mounting cavity 42a. Each latch tab 70 (FIGS. 3 and 4) of the dielectric insert 16a is received within the corresponding latch opening 52 (FIG. 2) of the mounting cavity 42a to hold the dielectric insert 16a within the mounting cavity 42a. The dielectric insert 16a is thereby held within the interior chamber 36 of the housing 12.

The electrical contact 14a is loaded into the contact channel 68 of the dielectric insert 16a in the direction of the arrow B. As the electrical contact 14a is loaded into the contact channel 68, the shoulder 92 of the sleeve 90 engages the resilient fingers 62 of the dielectric insert 16a. Engagement between the shoulder 92 and the resilient fingers 62 moves the tips 80 of the resilient fingers 62, against the bias thereof, radially outward relative to the central longitudinal axis 78 and toward the interior surface 76 of the base 60. The shoulder 92 thereby moves the tips 80 away from the locked position to enable the shoulder 92 to clear the tips 80. Once the shoulder 92 has passed the tips 80, the bias of the resilient fingers 62 moves the tips 80 back to the locked position, wherein the tips 80 engage the terminating segment 50a of the electrical contact 14a. Specifically, the end surfaces 82 of the tips 80 engage the shoulder 92 of the sleeve 90, while radially inner surfaces 94 of the tips 80 engage the sleeve 90 adjacent the shoulder 92. The resilient fingers 62 of the dielectric insert 16a thereby retain the electrical contact 14a within the interior chamber 36 of the housing 12. When retained in the interior chamber 36 of the housing 12, the terminating segment 50a of the electrical contact 14a extends within the contact channel 68 of the dielectric insert 16a and within the mounting cavity 42a of the housing base 20. The mating segment 40a of the electrical contact 14a extends through the opening 48 within the bottom 46 of the mating cavity 42a into the corresponding mating cavity 36a of the housing 12. The mating segment 40a of the electrical contact 14a thereby extends along the mating interface 30 of the housing 12.

To remove the electrical contact 14a from the interior chamber 36 of the housing 12, a tool (not shown) can be inserted into the contact channel 68 of the dielectric insert 16a within the space between the sleeve 90 and the interior surface 76 of the dielectric insert 16a. The tool engages the tips 80 of the resilient fingers 62 to move the tips 80, against the bias thereof, radially outward relative to the central longitudinal axis 78 and toward the interior surface 76. Once the tips 80 are moved radially outwardly past the shoulder 92 of the sleeve 90, the electrical contact 14a can be removed from the contact channel 68 of the dielectric insert 16a in the direction of the arrow C.

The dielectric inserts 16b, 16c, 16d, and 16e (FIG. 5) retain the corresponding electrical contacts 14 within the interior chamber 36 of the housing 12 in a substantially similar manner to the dielectric insert 16a, which therefore will not be described or illustrating in more detail herein. It should be understood, however, the corresponding electrical contacts 14 retained by the dielectric inserts 16b, 16c, 16d, and 16e may be different types of contacts from the electrical contact 14a and/or from each other. For example, one or more of the electrical contacts retained by the dielectric inserts 16b, 16c, 16d, and/or 16e may have a mating segment 40 that includes a receptacle (not shown) that receives a portion of the corresponding electrical contact (not shown) of the mating connector (not shown).

The embodiments described and/or illustrated herein may provide an electrical connector that is less expensive, less complex and/or has fewer components than at least some known electrical connectors. The embodiments described and/or illustrated herein may provide an electrical connector that is less expensive to assemble, less difficult to assemble, and/or takes less time to assemble than at least some known electrical connectors.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

1. An electrical connector comprising:
a housing having a mating interface and an interior chamber;
an electrical contact comprising a terminating segment and a mating segment, the terminating segment of the electrical contact comprising an inner shell and a sleeve extending at least partially around the inner shell; and
a dielectric insert held within the interior chamber of the housing, the dielectric insert comprising a contact channel and a resilient finger extending into the contact channel, the terminating segment of the electrical contact extending within the contact channel of the dielectric insert, the resilient finger being engaged with the sleeve of the terminating segment of the electrical contact to retain the electrical contact within the interior chamber of the housing such that the mating segment of the electrical contact extends along the mating interface of the housing.

2. The electrical connector according to claim 1, wherein the dielectric insert comprises a base, the resilient finger extending a length from the base to a tip, the tip of the resilient finger being engaged with the sleeve of the terminating segment of the electrical contact.

3. The electrical connector according to claim 1, wherein the dielectric insert comprises a base and the contact channel of the dielectric insert extends a length along a central longitudinal axis, the resilient finger of the dielectric insert extending from the base radially inward relative to the central longitudinal axis.

4. The electrical connector according to claim 1, wherein the dielectric insert comprises an interior surface that defines the contact channel, the resilient finger extending outwardly from the interior surface into the contact channel.

5. (canceled)

6. (canceled)

7. The electrical connector according to claim 1, wherein the sleeve comprises a shoulder, the resilient finger being engaged with the shoulder of the sleeve for retaining the electrical contact within the interior chamber of the housing.

8. The electrical connector according to claim 1, wherein the contact channel of the dielectric insert extends along a central longitudinal axis, the resilient finger comprises a tip having a locked position, the tip being movable from the locked position radially outward relative to the central longitudinal axis of the contact channel, the tip of the resilient finger being engaged with the sleeve of the terminating segment of the electrical contact when in the locked position.

9. The electrical connector according to claim 1, wherein the interior chamber of the housing comprises a mating cavity and a mounting cavity, the mounting cavity having a bottom, an opening extends through the bottom such that the mating and mounting cavities fluidly communicate with each other, the dielectric insert and the terminating segment of the electrical contact being held within the mounting cavity of the interior chamber, the mating segment of the electrical contact extending through the opening into the mating cavity of the interior chamber.

10. The electrical connector according to claim 1, wherein the dielectric insert comprises a latch element that cooperates with a latch feature of the housing to hold the dielectric insert within the interior chamber of the housing.

11. The electrical connector according to claim 1, wherein the terminating segment of the electrical contact comprises an end of the electrical contact.

12. The electrical connector according to claim 1, wherein the mating segment of the electrical contact comprises an end of the electrical contact.

13. An electrical connector comprising:
a housing having a mating interface and an interior chamber;
an electrical contact comprising a terminating segment and a mating segment, the terminating segment of the electrical contact comprising an inner shell and a sleeve extending at least partially around the inner shell; and
a dielectric insert held within the interior chamber of the housing, the dielectric insert comprising a base having a contact channel extending therethrough and resilient fingers extending from the base into the contact channel, the terminating segment of the electrical contact extending within the contact channel of the dielectric insert, the resilient fingers being spaced apart around a periphery of the terminating segment of the electrical contact, the resilient fingers comprising free ends that are engaged with the sleeve of the terminating segment of the electrical contact to retain the electrical contact within the interior chamber of the housing such that the mating segment of the electrical contact extends along the mating interface of the housing.

14. The electrical connector according to claim 13, wherein the contact channel of the dielectric insert extends a length along a central longitudinal axis, the resilient fingers of the dielectric insert extending from the base radially inward relative to the central longitudinal axis.

15. The electrical connector according to claim 13, wherein the dielectric insert comprises an interior surface that defines the contact channel, the resilient fingers extending outwardly from the interior surface into the contact channel.

16. (canceled)

17. (canceled)

18. The electrical connector according to claim 13, wherein the sleeve comprises a shoulder, the resilient fingers being engaged with the shoulder of the sleeve for retaining the electrical contact within the interior chamber of the housing.

19. The electrical connector according to claim 13, wherein the contact channel of the dielectric insert extends along a central longitudinal axis, the free ends of the resilient fingers comprising a locked position and being movable from the locked position radially outward relative to the central longitudinal axis of the contact channel, the free ends of the resilient fingers being engaged with the sleeve of the terminating segment of the electrical contact when in the locked position.

20. The electrical connector according to claim 13, wherein the interior chamber of the housing comprises a mating cavity and a mounting cavity, the mounting cavity having a bottom, an opening extends through the bottom such that the mating and mounting cavities fluidly communicate with each other, the dielectric insert and the terminating segment of the electrical contact being held within the mounting cavity of the interior chamber, the mating segment of the electrical contact extending through the opening into the mating cavity of the interior chamber.
